(19) United States
(12) Patent Application Publication
(10) Pub. No.: US 2014/0321501 A1
(43) Pub. Date: Oct. 30, 2014

(54) HOT BEARING DETECTION SYSTEM AND METHOD

(71) Applicant: PROGRESS RAIL SERVICES CORPORATION, Albertville, AL (US)

(72) Inventors: MARK J. BARTONEK, Independence, MO (US); Donald J. ARNDT, Napoleon, MO (US); Steven C. HAMERLE, Richmond, MO (US); Roland O'CONNELL, Lone Jack, MO (US)

(73) Assignee: Progress Rail Services Corporation, Albertville, AL (US)

(21) Appl. No.: 13/869,156

(22) Filed: Apr. 24, 2013

(51) Int. Cl. G01J 5/10

(52) U.S. Cl. CPC G01J 5/10; G01J 2005/0085
USPC 374/121

(57) ABSTRACT

The present disclosure is directed to a system and method for identifying a hot bearing. A processor may be configured for receiving a plurality of infrared (IR) signals emitted by a bearing as the bearing passes through a view window being monitored by one or more IR sensing elements positioned to receive IR radiation emitted from a target area of the bearing. The processor may extract IR data from IR signals emitted from an area within the target area of the bearing defined by a narrow window extending along a longitudinal axis for a length corresponding to substantially an entire length of the bearing. The processor may also establish a characteristic thermal profile from the extracted IR data, the characteristic thermal profile exhibiting identifiable boundaries of an area of interest on the bearing. The processor may compare temperatures of the bearing within the area of interest to a threshold, and produce an alarm signal if temperatures of the bearing within the area of interest exceed the threshold.

### TECHNICAL FIELD

The present disclosure relates generally to a detection system and method and, more particularly, a hot bearing detection system and method.

### BACKGROUND

Monitoring systems for the railroad industry provide methods and apparatus for automatic determination of the temperatures of components including bearings on passing trains. Infrared (IR) radiation emitted from the bearing of a train traveling along a train track is indicative of a temperature or temperature range of the bearing. IR scanners and associated circuits for detecting an overheated wheel or wheel bearing are available commercially. Some systems utilize an IR detector located in close proximity to the railroad tracks. The IR detector determines the presence of emitted IR waves within a predefined range of wavelengths. The IR detector also produces an output signal indicative of the power or intensity of the sensed IR radiation within the predefined range.

One problem associated with these types of systems for detecting a temperature range or a temperature of a railroad train wheel or wheel bearing involves inaccuracies that may result under different conditions. In situations where the range of detected IR waves is attenuated or filtered by external sources such as blowing snow, wind, rain, or other weather conditions, the result is an inaccurate detection of a hot wheel or hot bearing condition. Another problem involves determining a temperature of a bearing in close proximity to support structures and other railcar undercarriage features that result in a limited window and time period during which accurate temperature detection may occur with the bearing moving by the detectors at high speeds. In existing systems only a portion of the bearing, such as the inner race of the bearing, is scanned, thereby potentially missing other areas of the bearing that may be overheating. Different configurations of different bearings that may be encountered can also lead to false indications of hot bearings when existing IR scanners pick up readings from portions of the bearing that are not areas of concern. Certain portions of a bearing assembly may be expected to emit higher levels of IR energy than may be considered safe if emitted from other portions of the bearing. Accurate detection of an overheated component such as a bearing allows for corrective actions to be taken before the overheated component breaks down or fails.

One attempt to avoid the problem of inaccurate detection of wheel and wheel bearing temperatures in a harsh environment is disclosed in U.S. Pat. No. 6,872,945 to M. Bartonek that issued on Mar. 29, 2005 (the '945 patent). The '945 patent discloses an apparatus that includes a sensor for sensing IR radiation radiating from a train wheel or wheel bearing within two or more IR wavelength ranges, where each wavelength range does not substantially overlap with any other wavelength range. The sensor generates signals indicative of the sensed IR radiation in each of the wavelength ranges. A processor determines a temperature range or a temperature of the wheel or wheel bearing from the generated signals.

The temperature detection system of the '945 patent may determine a temperature of a wheel or wheel bearing of a train traversing a railroad track. Furthermore, the temperature detection system of the '945 patent may not be susceptible to variations in the amplitude, intensity, or power of the detected IR radiation. However, improvements to the length of time needed to obtain accurate temperature measurements and the time needed to identify a potential problem for a moving wheel bearing may still be possible.

The system and method of the present disclosure solves one or more problems set forth above and/or other problems in the art.

### SUMMARY

In one aspect, the present disclosure is directed to a method for identifying a hot bearing. The method may include receiving a plurality of infrared (IR) signals emitted by a bearing as the bearing passes through a view window being monitored by one or more IR sensing elements positioned to receive IR radiation emitted from a target area of the bearing. The method may further include extracting IR data from IR signals emitted from an area within the target area of the bearing defined by a narrow window extending along a longitudinal axis for a length corresponding to substantially an entire length of the bearing. The method may also include establishing a characteristic thermal profile from the extracted IR data, the characteristic thermal profile exhibiting identifiable boundaries of an area of interest on the bearing, comparing temperatures of the bearing within the area of interest to a threshold, and producing an alarm signal if temperatures of the bearing within the area of interest exceed the threshold.

In another aspect, the present disclosure is directed to a system for identifying a hot bearing. The system may include one or more infrared (IR) sensing elements positioned to receive IR radiation emitted from a target area of a bearing. The system may further include a processor configured for receiving a plurality of IR signals emitted by the bearing as the bearing passes through a view window being monitored by the one or more IR sensing elements. The processor may be further configured for extracting IR data from IR signals emitted from an area within the target area of the bearing defined by a narrow window extending along a longitudinal axis for a length corresponding to substantially an entire length of the bearing, establishing a characteristic thermal profile from the extracted IR data, the characteristic thermal profile exhibiting identifiable boundaries of an area of interest on the bearing, comparing temperatures of the bearing within the area of interest to a threshold, and producing an alarm signal if temperatures of the bearing within the area of interest exceed the threshold.

### BRIEF DESCRIPTION OF THE DRAWINGS

FIG. 1 is a schematic illustration of an exemplary disclosed bearing temperature detection system;

FIG. 2 is a schematic illustration of exemplary features of the exemplary disclosed bearing temperature detection system of FIG. 1;

FIG. 3 is a schematic illustration of exemplary features of the exemplary disclosed bearing temperature detection system of FIG. 1; and

FIG. 4 is a flowchart illustrating an exemplary method that may be performed by the bearing temperature detection system of FIG. 1.

### DETAILED DESCRIPTION

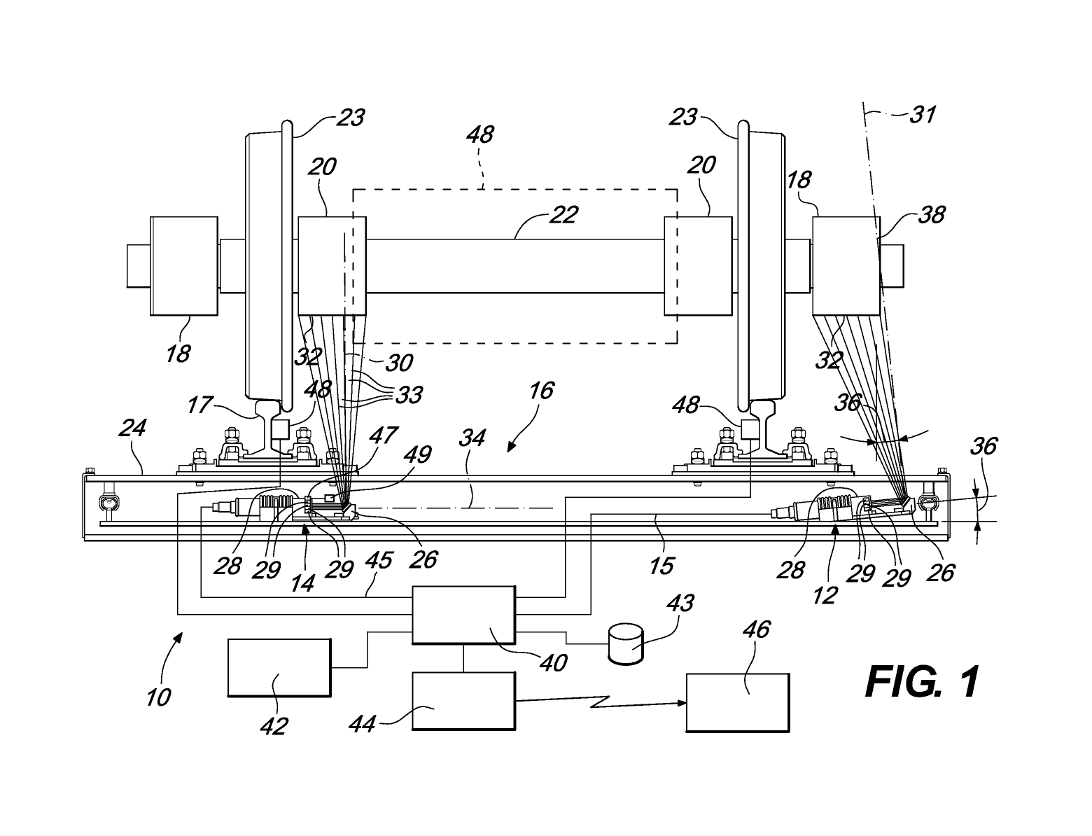

FIG. 1 illustrates an exemplary temperature detection system 10 for detecting bearing temperatures. One or more sensors, such as an outer bearing sensor 12 and an inner bearing sensor 14, may be placed in a position along a rail 17 to obtain data from bearings, such as an inner bearing 20 and an outer bearing 18, of a train axle 22 as the axle passes sensors 12, 14. The sensors 12, 14 may be positioned in a rail bed 16 of rail 17, such as within a cross tie or sleeper 24 adapted to contain sensors 12, 14, and to receive IR emissions from bearings 18, 20. Alternatively, or in addition, sensors 12, 14 may be clamped to a rail 17, or otherwise mounted in proximity to a rail 17, and oriented to look parallel to rail 17, or at other angles to rail 17, and angled up at a 45 degree angle or other angle that provides a good view of all or portions of a passing bearing on a train. In various implementations of the disclosure, each sensor 12, 14 may include a mirror 26 and/or lens 27 or other IR optical components to redirect IR emissions into a receiver 28 of sensors 12, 14 to allow receiver 28 to be oriented horizontally within sleeper 24. Additional variations may include one or more lenses 27 or other optical components positioned in the path of IR emissions received from bearings 18, 20 for redirecting, focusing, or otherwise processing the IR emissions. Sensors 12, 14 may be positioned along an axis 34 parallel to train axle 22 to receive IR emissions 33 emitted from a bottom 32 of a bearing 18, 20 along a path 30 perpendicular to axle 22. The emissions may be redirected by mirror 26, for example, at a right angle with respect to path 30, through one or more lenses 27 or other optical components, and into receiver 28.

In accordance with various implementations of this disclosure, each sensor 12, 14 may include a plurality of infrared sensing elements 29, such as IR radiation sensitive diode detectors, or an IR sensitive planar array having individually resolvable pixels, arranged, for example, vertically within receiver 28 to receive respective portions 33 of the IR emissions radiated by respective bearings 18, 20. Two main types of IR detectors may include thermal and photonic detectors. The thermal effects of incident IR radiation may be detected in accordance with many temperature dependent phenomena. Examples of these temperature dependent phenomena may include changes in the electrical resistance of the material of the temperature sensors, changes in physical characteristics of the temperature sensors, and excitation of electrons in the sensors caused by impingement of photons on the sensors. Different types of IR detectors may include IR non-imaging sensors, IR imaging sensors, semiconductor IR detectors made from mercury cadmium telluride (HgCdTe) (sometimes referred to as MerCaT detectors), semiconductor IR detectors made from indium antimonide (InSb), semiconductor IR detectors made from mercury zinc telluride (HgZnTe), semiconductor IR detectors made from III-V semiconductor materials such as GaAs and AlGaAs, silicon-based thermal bolometers, photon-counting superconducting tunnel junction (STJ) arrays, quantum well IR photodetectors (QWIP), quantum dot IR photodetectors (QDIP), based on either a colloidal or type-II superlattice structure, photovoltaic sensors, piezoelectric sensors, pyroelectric sensors, and thermopiles or groups of thermocouples.

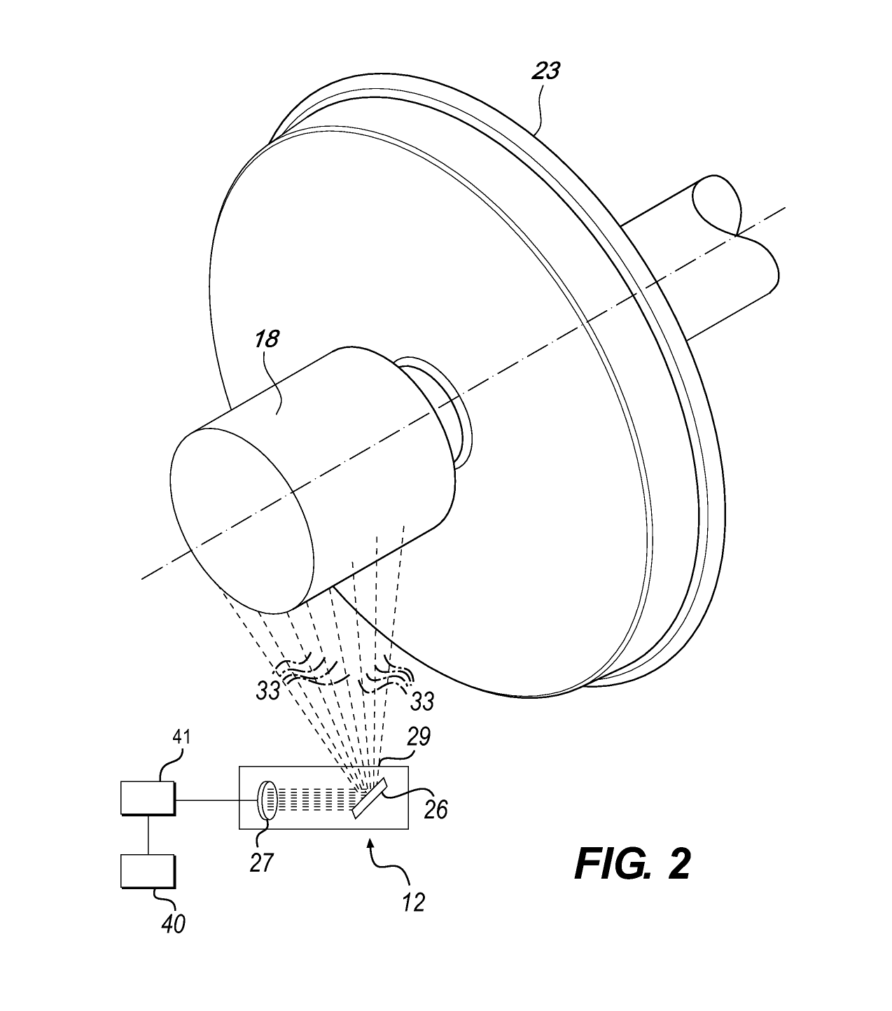

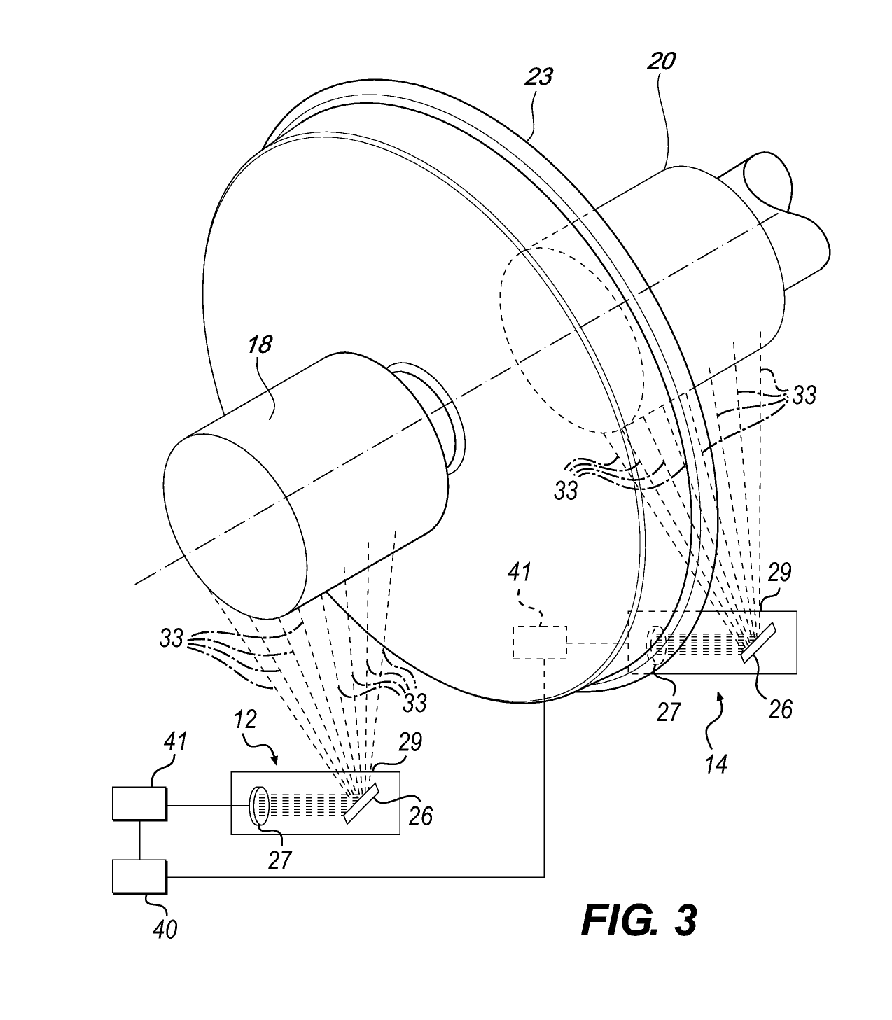

An IR non-imaging sensor may collect IR radiation only at a single point, while an IR imaging sensor may collect IR radiation at multiple points, which can form an array, and can provide data that may be used to create one or more thermal images. In alternative implementations, each sensor 12, 14 may include an IR line scanner or scanners, or other type of IR scanner configured to receive IR emissions along a longitudinal axis long enough to encompass the entire length of a bearing 18 or 20, and extending in a direction transverse to a direction of travel of the train. IR sensing elements 29 of the IR scanner may be configured and oriented to receive IR emissions from a target area on a bearing that may encompass, for example, an array that is approximately 200 by 300 pixels in area and extending across the entire length of bearing 18, 20. A thermal profile derived from this initial scan may be processed by an autonomous processor 41 associated with each sensor 12, 14, as shown in FIGS. 2 and 3. Each autonomous processor 41 may be located near an associated sensor 12, 14, and configured for receiving an array of IR energy data emitted from an area of a component that passes within a view window of the sensor. Each autonomous processor 41 may be further configured for employing pattern recognition software or algorithms in order to recognize a characteristic thermal fingerprint for a hot bearing. Upon recognizing a characteristic thermal fingerprint for a hot bearing, autonomous processor 41 may be configured for converting the IR energy data in an identified area of interest within the larger thermal profile into actual temperature data. The recognition of a characteristic thermal fingerprint for a hot bearing may enable autonomous processor 41 to quickly target only a specific area of IR data received by the array of sensing elements 29 for further processing.

In various implementations of this disclosure, the identified area of interest may be from one to several pixels wide in a direction of a perimeter of the bearing and from 9 inches to 12 inches long along a length of the bearing transverse to a direction of travel of the train. Autonomous processor 41 may be configured to only extract IR data originating along this narrow window extending the length of the bearing for further processing. The extraction of IR data originating along only a narrow width of the entire area of IR emissions received by an array of IR sensing elements 29 may enable a focus on a portion of the bearing that will be in a clear line of sight from sensors 12, 14, unobstructed by other equipment such as truck structure for supporting the bearing. This targeting of a narrow window of extracted IR data based on a recognized thermal fingerprint may help to reduce false warnings that could result from extraneous thermal data received from portions of a bearing that are not of concern, or from other bearings or nearby components. Furthermore, the narrow width of IR data extracted for further processing by autonomous processors 41 associated with each sensor may significantly reduce the total area of emitted IR energy that must be received, converted to temperatures, and monitored in the short period of time that is available when the bearing passes by quickly. This may increase the speed of response and accuracy of temperature measurements made with information received by IR sensing elements 29. For example, with the typical spacing between axles on a railcar, and at the higher speeds passenger trains and some freight trains may be traveling, the target window may only be available for less than a millisecond.

A narrow window of extracted IR data may be defined as encompassing only 1 to several pixels of IR data in a direction perpendicular to the length of the longitudinal axis. The line of extracted thermal data may provide information on the temperatures of the various components of the entire bearing assembly, including an inner bearing race, an outer bearing race, inboard and outboard bearing elements of a bearing assembly, the rolling elements of the bearing, grease seals on the outside of the outer bearing race and on the inside of the inner bearing race, and bearing caps. Autonomous processors 41 associated with each sensor 12, 14 may be configured to only extract IR data originating from a narrow window extending along a longitudinal axis across a broader array or matrix of IR data received by an array of IR sensing elements 29. The focus on a narrow window of thermal data along a longitudinal axis that encompasses the entire length of the passing bearing may speed up processing time and avoid consideration of spurious temperature readings produced by portions of the bearing or surrounding features that are not of interest. After extracting the desired focused area of IR data, and converting this information to actual temperatures, each autonomous processor 41 may be configured to provide this temperature data to another processor 40 for further processing and evaluation.

Each infrared sensing element 29 may receive a respective portion of IR energy from a target area, such as bottom 32 or end face 38 of bearings 18, 20, spaced away from portions of IR emissions received by other IR sensing elements 29 of the sensor. Sensors 12, 14 may include IR sensing elements 29 such as Mercury/Cadmium/Tellurium (HgCdTe) elements. IR sensing elements 29 may be positioned in an array that may gather IR emissions data across an area of a passing bearing that is significantly larger than an area that is actually of potential concern. Accordingly, autonomous processors 41 may greatly expedite total processing time by extracting IR data that originated along a width that may be only one to several pixels wide and along a length that may be long enough to encompass or transgress an entire bearing. The extracted IR data may then be converted by autonomous processors 41 into actual temperature data and this focused data may then be passed on to processor 40. The width of the area of bearings 18, 20 that may be monitored by IR sensing elements 29 may extend in a direction around an outer perimeter of each bearing 18, 20. In various exemplary implementations sensors 12, 14 may also receive emitted thermal radiation through an IR lens and/or may be positioned to view the bearings through an external shutter mounted in the instrumented tie or sleeper 24, with a front surface mirror 26 in the viewing path. The minor 26 may include a gold front surface to resist tarnishing or bonding with other materials. Minor 26 may be rotated, such as at 10,000 revolutions per minute, to discard contaminants that may come to rest on the mirror 26. Alternative implementations may include mounting sensors 12, 14 directly to rails 17, directly in the ballast between or outside of rails 17, or on other mounting structures.

While the perpendicular orientation of path 30 may allow sensors 12, 14 to receive IR radiation unblocked by other components, (such as suspension components positioned near bearings 12, 14) an unimpeded path from bearings 18, 20 to minors 26 may not be possible to achieve in some cases. For example, bottom 32 of outer bearing 18 may be obscured by a shroud (not shown), thereby rendering it difficult to maintain a clear path to the bottom 32 of outer bearing 18 for receiving IR emissions. Therefore, in certain implementations of the disclosure, outer bearing sensor 12 may be inclined from axis 34 by an angle 36 so that an outer bearing imaging path 31 may be inclined away from perpendicular with respect to axle 22 by corresponding angle 36. For example, the bearing imaging path 31 may be positioned at an acute angle with respect to end face 38 of outer bearing 18. Consequently, an IR emission radiated from an unobscured portion of outer bearing 18, such as end face 38 of outer bearing 18, may be sensed by sensor 12 positioned in rail bed 16 below the train without interference from components positioned near bearing 18. In various alternative implementations one or more sensors 12, 14 may be positioned to view portions or all of each bearing 18, 20 by looking out from an edge of sleeper 24 through a transparent window or lens, looking vertically out of sleeper 24, looking at a 45 degree or other angle relative to sleeper 24 and in a direction parallel to sleeper 24, looking at a 45 degree or other angle relative to sleeper 24 from a position in between rails 17, such as illustrated by sensor 14 in FIG. 1, or looking in a direction parallel to rails 17 from a mounting location on the outside of a rail 17, and angled up at a 45 degree or other angle to provide a desired view of a passing bearing.

The IR emissions received from the respective portions of IR emissions 33 originating at a bearing 18, 20 may be converted by IR sensing elements 29 into respective signals indicative of a strength of the IR energy received. These signals may be provided to autonomous processors 41 and processor 40 for further signal processing, including extraction of IR data along the narrow window discussed above, converting IR energy signals to actual temperatures and further processing the temperatures to determine indications of abnormal bearing heating.

In various implementations processor 40 may be disposed remotely from sleeper 24 and may be connected to sensors 12, 14 via respective cables 15, 45. Processor 40 may further receive wheel passage information provided by one or more wheel sensors 48 such as inductive sensors, for example, spaced longitudinally along rail 17. Processor 40 may be in communication with memory 42, for example, to receive analytically and/or experimentally derived radiation pattern information from memory 42 to perform pattern recognition analysis in accordance with an aspect of the disclosure. Processed information, such as information identifying a bearing condition of a sensed bearing, may be transmitted via transmitter 44 to a central monitor 46 for reporting and/or notification of a degraded bearing condition requiring servicing.

Processor 40 may also be in communication with a train database 43 having reference information for each passing vehicle to the relative axle count within the train and the relative vehicle position within the train. For example, the reference information may be downloaded from a remote source via transmitter 44 being configured as a transceiver for receiving and transmitting information. In another aspect, specific registered car number data from an external system, such as an AEI tag reader system, may be input to database 43 to tag the vehicle data with a unique vehicle registration number.

An improved detection system capable of rapidly and accurately identifying elevated bearing temperatures for a variety of bearing configurations, and conditions of these bearings includes performing one or more innovative processes on the received IR energy to determine a temperature of the bearing from which a health condition of the bearing may be inferred. A thermal profile may be generated for the portion of the bearing targeted by an array of IR sensing elements 29 configured to receive IR emissions from an area of bearings 18, 20 larger than an actual area of potential interest. As discussed above, thermal data for further processing may be extracted by autonomous processors 41 from the array of IR data received by IR sensing elements 29, with the extracted data originating from a narrow window along a substantially longitudinal axis encompassing the length of the bearing.

Characteristic features of this thermal profile along a substantially longitudinal axis transgressing the bearing may identify a thermal fingerprint that corresponds to a hot bearing exhibiting temperatures above a certain threshold. Certain portions of a typical bearing may exhibit temperature characteristics that provide identifiable boundaries to an area of the bearing that may be of concern when temperatures above a certain threshold are reached in that area. An area of interest on the bearing may be any portion of the bearing where it may be desirable to monitor the temperature as a potential indication of a problem when the temperature exceeds a predefined threshold. Autonomous processors 41 and/or processor 40 may be configured to extract thermal data transgressing the identifiable boundaries and only evaluate or further process temperatures in the area of the bearing falling within the identified boundaries. In particular, one exemplary implementation of processor 40 may be configured to recognize temperature spikes along the thermal profile corresponding to the temperatures of a grease seal at each end of the bearing. By only extracting and/or evaluating thermal data along the portion of the longitudinal axis falling between the boundaries identified by these temperature spikes, autonomous processors 41 and/or processor 40 may be configured to use significantly less processing time in evaluating received IR emissions. In this way autonomous processors 41 and processor 40 may be configured to significantly increase the speed at which temperatures of possible concern in specific targeted areas of a passing bearing may be identified.

In various implementations of this disclosure, wheel detection pulses may also be generated, for example, by inductive wheel sensors 48 as a train wheel 23 passes wheel sensor 48. IR emissions data may be continuously collected by autonomous processors 41 and processor 40 monitoring the data received from the IR sensors 12, 14, relative, for example, to a time when a wheel 23 is initially detected, as indicated by a rising edge of a first wheel detection pulse. Data collection may be completed at a time relative to a falling edge of a second wheel detection pulse. Accordingly, a timing of IR emissions capture may be correlated with arrival of a wheel 23 to ensure that bearing IR emissions corresponding to the passing wheel 23 are captured.

FIG. 2 illustrates one possible implementation of a portion of an exemplary bearing temperature detection system wherein sensor 12 includes a plurality of IR sensing elements 29 arranged to receive IR radiation emitted from an area along a bottom surface of bearing 18. IR emissions 33 from bearing 18 may be reflected by a minor 26 of sensor 12 and focused by at least a lens 27, or other IR optical component of sensor 12 before impinging upon IR sensing elements 29 contained within sensor 12. IR energy data from the received IR emissions may then be sent to autonomous processor 41 associated with sensor 12. Autonomous processor 41 may be configured to extract only IR data originating in a narrow window of one to several pixels in width and extending along a substantially longitudinal axis of bearing 18 transgressing substantially the entire length of bearing 18. Autonomous processor 41 may be configured to target the specific IR data for extraction based at least in part upon pattern recognition of a thermal fingerprint characterizing the portions of bearing 18 that are of interest. FIG. 3 similarly illustrates sensor 14 including a plurality of IR sensing elements 29 arranged to receive IR radiation emitted from an area along a bottom surface of bearing 20. IR emissions 33 from bearing 20 may be reflected by a mirror 26 of sensor 14 and focused by at least a lens 27, or other IR optical component of sensor 14 before impinging upon IR sensing elements 29 contained within sensor 14. IR energy data from the received IR emissions may then be sent to autonomous processor 41 associated with sensor 14. Autonomous processor 41 may be configured to extract only IR data originating in a narrow window of one to several pixels in width and extending along a substantially longitudinal axis of bearing 20 and transgressing substantially the entire length of bearing 20. Autonomous processor 41 may be configured to target the specific IR data for extraction based at least in part upon pattern recognition of a thermal fingerprint characterizing the portions of bearing 20 that are of interest.

One of ordinary skill in the art will recognize that alternative implementations may include an arrangement of IR sensing elements 29 in a sensor 12, 14 configured to receive IR data originating only from a defined area along a bearing 18, 20. Various mirrors, lenses, or other optical elements may be arranged within a sensor 12, 14 so that only IR data emitted along a narrow window of one to several pixels in width, and extending along a longitudinal axis that at least substantially transgresses or encompasses the entire length of a bearing is actually focused onto an array of IR sensing elements 29. In these alternative implementations, the entire amount of IR data received by IR sensing elements 29 may be kept to a minimum while still allowing for a thermal profile or characteristic thermal fingerprint to be developed for the entire length of the bearing.

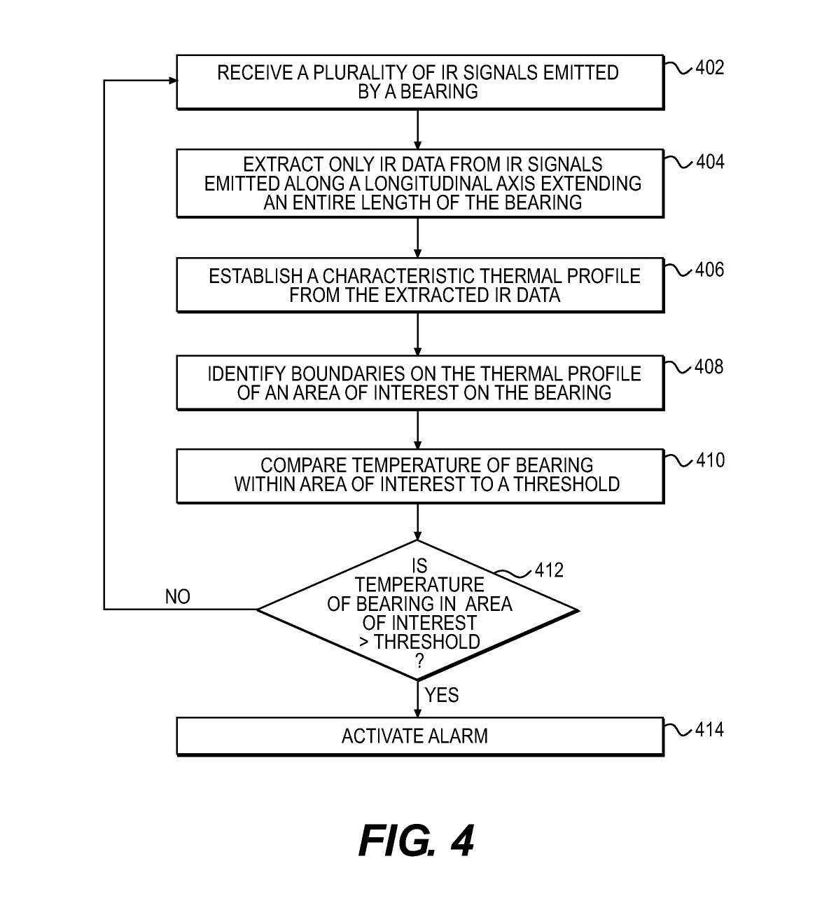

FIG. 4 illustrates an exemplary implementation of a method that may be performed by the bearing temperature detection system shown in FIGS. 1-3. FIG. 4 will be discussed in more detail below to further illustrate the disclosed concepts.

### INDUSTRIAL APPLICABILITY

The disclosed method and system may allow for increasing the speed and accuracy of detecting temperatures of bearings on train cars that may be moving at high rates of speed. In accordance with various exemplary implementations, IR data may be received from an array of IR sensing elements, and only data received from a narrow window along a substantially longitudinal axis that transgresses substantially the entire bearing may be subjected to further evaluation and processing. A bearing temperature detection system 10 may be used to obtain data, such as IR emission data, indicative of a temperature of a bearing as the vehicle rolls past a sensing device of the system. The system may include a sensing device oriented to receive unobstructed IR emissions from rail car undercarriage components. In one aspect, a sensor may include an array of IR sensing elements sensing IR radiation emitted from a target area of a component, such as a bearing of an axle, respectively. The data received from the sensing devices may then be processed to extract information indicative of a health of the respective sensed component. The data may be processed to convert IR energy data into temperatures and recognize a characteristic waveform profile or thermal fingerprint. Recognition of a characteristic thermal fingerprint may enable extraction of only IR data originating from an area of interest on the sensed component. This may facilitate reduction in total processing time required to identify a temperature of the component that may be of concern, as well reducing spurious IR emissions received from IR sources in the vicinity of a sensed component. A suspension for the system mounted within a railroad tie, or sleeper, may also be provided to reduce the effects of shock and vibration that may be experienced by the system. Waveform analysis methods may be used on the data to identify types of components or portions of components for which temperature readings are being monitored.

As discussed above, various implementations of this disclosure may include arranging IR sensing elements 29 in an array within each sensor 12, 14 to receive IR radiation emitted from an area on a passing bearing. The emitted IR radiation may be directed by various optical components including one or more mirrors, lenses, or other components before impinging upon the array of IR sensing elements 29. Autonomous processors 41 may receive the IR data from IR sensing elements 29, and may target for extraction only data received from a narrow window along a longitudinal axis transgressing the entire length of a passing bearing. A narrow window may be defined as only one to several pixels wide in a direction of a perimeter of the bearing, and extending along a substantially longitudinal axis that transgresses substantially the entire length of the bearing in a direction approximately transverse to a direction of train travel. Various types of temperature sensors may provide different advantages and different disadvantages, or different strengths and different weaknesses, such that selecting more than one type of sensor to measure temperatures of bearings can provide a way of checking the consistency and reliability of the acquired data. As discussed above, one implementation may utilize a plurality of thermal bolometers, each configured and positioned to receive portions of IR emissions from a different point along a substantially longitudinal axis transgressing substantially the entire length of the bearing. Autonomous processors 41 and/or processor 40 may receive output signals from the various types of sensors, process the signals received from the sensors, and combine the results into outputs that may be more accurate and reliable than the outputs from a single type of temperature sensor.

Various implementations of this disclosure may provide one or more technical results. For example, one technical result may be that computer code executed by a computer processor or module within an autonomous processor 41 in accordance with various features of this disclosure may extract only IR data received from portions of a bearing along a substantially longitudinal axis transgressing the entire bearing. In certain implementations the extracted data may cover only 1 to several pixels in width and between approximately 9 inches and 12 inches in length. A processor 41, 40 may process this extracted IR data to generate and plot a thermal profile or characteristic thermal fingerprint for the bearing.

Referring to the flow chart of FIG. 4, at step 402 an array of IR sensing elements, such as an IR line scanner, receive a plurality of IR signals emitted by a bearing as a target area of the bearing passes through a view window being monitored by an IR sensor.

At step 404, a processor may extract only IR data from IR signals emitted along a longitudinal axis extending substantially an entire length of the bearing. In various exemplary implementations this length may fall within a range from approximately 9 inches to approximately 12 inches long. By focusing only on IR data emitted along a longitudinal axis, for example, by looking at only a narrow window of approximately one to several pixels width of IR data along the longitudinal axis, processing time may be reduced. The number of pixels of IR information that are evaluated and processed along the entire length of the longitudinal axis may be selected to provide a thermal profile that transgresses the entire length of the bearing.

At step 406, the processor may establish a characteristic thermal profile from the extracted IR data. This thermal profile may be plotted and stored to create a database of characteristic thermal profiles for various bearings commonly monitored by the system. A characteristic thermal profile may be recognized and matched to existing stored thermal profiles using pattern recognition software.

At step 408, the processor may identify boundaries on the thermal profile of an area of interest on the bearing. For example, a typical thermal profile for a bearing may exhibit temperature spikes at opposite ends of the bearing where the grease seals are located. The processor may recognize these temperature spikes and identify these spikes as boundaries of the area of the bearing that is of interest, including inner and outer races, inboard and outboard bearing elements, and the bearing rolling elements. In alternative implementations the area of interest may include areas of the bearing outside of the features such as grease seals that may result in identifiable boundaries. In situations such as these, IR data for the areas outside of the identifiable boundaries may be extrapolated from data corresponding to areas of the bearing in between the identifiable boundaries. By scanning the entire length of a bearing assembly, encompassing inner and outer races, inboard and outboard bearing elements, grease seals, and bearing caps, and extracting IR data along a narrow window for the entire length, various implementations of the system and method of this disclosure may help to eliminate false high temperature readings such as those caused by the grease seals. As discussed above, the grease seals may leave characteristic temperature spikes along the typical thermal profile for a bearing, and allow processor 40 or autonomous processors 41 to quickly identify areas of interest on portions of the bearing where abnormally high temperatures may be cause for concern.

At step 410, the processor may compare the temperatures of the bearing in the area of interest to one or more thresholds. At step 412, the processor may make a determination as to whether the temperature of the bearing in the area of interest is greater than the threshold. If the temperature of the bearing in the area of interest is greater than the threshold (Step 412: Yes) then the processor may activate an alarm at step 414. If the temperature of the bearing in the area of interest is not greater than the threshold (Step 412: No) then the processor may return to step 402 and continue to receive IR signals emitted by passing bearings.

A technical result from monitoring and evaluating only temperature data retrieved from a very focused area of the bearing along a portion of a longitudinal axis transgressing the entire bearing is that the processing time may be significantly reduced and accuracy may be significantly improved. Complex pattern recognition is not required since the processor may have predetermined, for example, that particular temperature spikes along the narrow, longitudinal axis are characteristic of grease seals, and that the temperatures of interest are simply the temperatures in between the boundaries formed by these readily recognizable spikes. In various alternative implementations, the processor may also extrapolate temperature information outside these easily identifiable boundaries, in order to monitor temperatures of other features of the bearing that are of interest outside of the grease seals, such as the backing ring. Another technical result from the disclosed system and processes may be the accurate detection of a defect or operating characteristic, or an emerging trend in certain detected characteristics to forecast and/or prevent accidents and/or damage to the system being monitored (or to one or more of its components).

It will be apparent to those skilled in the art that various modifications and variations can be made to the disclosed temperature detecting system without departing from the scope of the disclosure. Other embodiments of the temperature detecting system will be apparent to those skilled in the art from consideration of the specification and practice of the temperature detecting system disclosed herein. It is intended that the specification and examples be considered as exemplary only, with a true scope of the disclosure being indicated by the following claims and their equivalents.

What is claimed is:

1. A method for identifying a hot bearing, the method comprising:
receiving a plurality of infrared (IR) signals emitted by a bearing as the bearing passes through a view window being monitored by one or more IR sensing elements positioned to receive IR radiation emitted from a target area of the bearing;
extracting IR data from IR signals emitted from an area within the target area of the bearing defined by a narrow window extending along a longitudinal axis for a length corresponding to substantially an entire length of the bearing;
establishing a characteristic thermal profile from the extracted IR data, the characteristic thermal profile exhibiting identifiable boundaries of an area of interest on the bearing;
comparing temperatures of the bearing within the area of interest to a threshold; and
producing an alarm signal if temperatures of the bearing within the area of interest exceed the threshold.

2. The method of claim 1, wherein the one or more IR sensing elements are arranged in a line corresponding to the narrow window extending along the longitudinal axis and are configured and oriented to receive a line of IR data that is approximately 1 to 6 pixels in width and approximately 9 inches to 12 inches in length.

3. The method of claim 1, wherein the one or more IR sensing elements are arranged in a matrix configured and oriented to receive IR data emitted from the bearing over an area larger than and encompassing the narrow window extending along the longitudinal axis.

4. The method of claim 1, wherein establishing a characteristic thermal profile includes identifying temperature spikes along the thermal profile indicative of higher temperatures associated with particular portions of the bearing.

5. The method of claim 4, wherein identifying temperature spikes along the thermal profile includes identifying temperature spikes caused by grease seal portions of the bearing.

6. The method of claim 4, wherein identifying temperature spikes along the temperature profile includes establishing the identified temperature spikes as the identifiable boundaries of an area of interest on the bearing.

7. The method of claim 1, further including:
extrapolating IR data from the thermal profile relative to the identifiable boundaries to determine a temperature of a particular component of the bearing.

8. The method of claim 1, further including:
positioning the one or more IR sensing elements in fixed positions relative to a rail along which a railcar including the bearing travels; and
orienting the one or more IR sensing elements so as to have an unobstructed line of sight to the target area of the bearing.

9. The method of claim 1, further including:
receiving a wheel position signal provided by a wheel sensor; and
extracting IR data from IR signals emitted from a narrow window extending along the longitudinal axis relative to a time when the wheel is detected by the wheel sensor.

10. A system for identifying a hot bearing, the system comprising:
one or more infrared (IR) sensing elements positioned to receive IR radiation emitted from a target area of a bearing; and
a processor configured for:
receiving a plurality of IR signals emitted by the bearing as the bearing passes through a view window being monitored by the one or more IR sensing elements;
extracting IR data from IR signals emitted from an area within the target area of the bearing defined by a narrow window extending along a longitudinal axis for a length corresponding to substantially an entire length of the bearing;
establishing a characteristic thermal profile from the extracted IR data, the characteristic thermal profile exhibiting identifiable boundaries of an area of interest on the bearing;
comparing temperatures of the bearing within the area of interest to a threshold; and
producing an alarm signal if temperatures of the bearing within the area of interest exceed the threshold.

11. The system of claim 10, wherein the one or more IR sensing elements are arranged in a matrix configured and oriented to receive IR data emitted from the bearing over an area larger than and encompassing the narrow window extending along the longitudinal axis.

12. The system of claim 10, wherein the processor is configured for establishing a characteristic thermal profile from extracted IR data by identifying temperature spikes along the thermal profile indicative of higher temperatures associated with particular portions of the bearing.

13. The system of claim 12, wherein the processor is configured for identifying temperature spikes along the thermal profile by identifying temperature spikes caused by grease seal portions of the bearing.

14. The system of claim 12, wherein the processor is configured for identifying temperature spikes along the temperature profile and establishing identified temperature spikes as identifiable boundaries of an area of interest on the bearing.

15. The system of claim 10, wherein the processor is further configured for extrapolating IR data from the thermal profile relative to the identifiable boundaries of an area of interest to determine a temperature of a particular component of the bearing.

16. The system of claim 10, wherein the one or more IR sensing elements are positioned in fixed positions relative to a rail along which a railcar including the bearing travels, and each of the one or more IR sensing elements is oriented so as to have an unobstructed line of sight to the target area of the bearing.

17. The system of claim 10, further including:
one or more wheel sensors configured to produce a wheel position signal when a wheel including the bearing passes by the one or more IR sensing elements; and
wherein the processor is further configured for extracting IR data from IR signals emitted from an area defined by a narrow window extending along the longitudinal axis relative to a time when the wheel is detected by the one or more wheel sensors.

18. The system of claim 10, wherein the one or more IR sensing elements are mounted in a sleeper tie replacing a regular tie used to support rails along which a railcar including the bearing travels.

19. The system of claim 18, wherein the one or more IR sensing elements are fixedly mounted in a position relative to a rail along which a railcar including the bearing travels, the position being selected to provide an unobstructed line of sight from the one or more IR sensing elements to the narrow window extending along the longitudinal axis for a length corresponding to an entire length of the bearing.

20. A system for identifying a hot bearing, the system comprising:
one or more infrared (IR) sensing elements positioned to receive IR radiation emitted from a target area of a bearing; and
a processor configured for:
receiving a plurality of IR signals emitted by the bearing as the bearing passes through a view window being monitored by the one or more IR sensing elements;
extracting IR data from IR signals emitted from an area within the target area of the bearing defined by a narrow window extending along a longitudinal axis for a length corresponding to an entire length of the bearing;
establishing a characteristic thermal profile from the extracted IR data, the characteristic thermal profile exhibiting identifiable boundaries of an area of interest on the bearing, wherein the identifiable boundaries of an area of interest on the bearing are temperature spikes along the thermal profile indicative of higher temperatures associated with particular portions of the bearing;
comparing temperatures of the bearing within the area of interest to a threshold; and
producing an alarm signal if temperatures of the bearing within the area of interest exceed the threshold.
